(19) United States
(12) Patent Application Publication
(10) Pub. No.: US 2023/0261405 A1
(43) Pub. Date: Aug. 17, 2023

(54) CABLE ASSEMBLY

(71) Applicant: STRAUSS WATER LTD, Or Yehuda (IL)

(72) Inventors: Omer BEN BARUCH, Kiryat Ono (IL); Eyal KRYSTAL, Kfar-Saba (IL); Dany ASCHER, Kibbutz Mishmarot (IL); Meira EREZ, Modiie'n (IL); Orly NAHUM, Ramat Gan (IL)

(21) Appl. No.: 18/003,526

(22) PCT Filed: Jul. 1, 2021
(86) PCT No.: PCT/IL2021/050818

§ 371 Date: Dec. 28, 2022

(30) Foreign Application Priority Data
Jul. 1, 2020 (IL) 275786

(51) Int. Cl. H01R 13/00; F16L 25/01; H01R 13/631; H01R 13/639; H01R 13/52; F16L 11/127

(52) U.S. Cl. CPC H01R 13/005; F16L 25/01; H01R 13/631; H01R 13/639; H01R 13/52; F16L 11/127; B67D 2210/00049; B67D 2210/00062

(57) ABSTRACT

The present disclosure provides composite cables, particularly multipurpose composite cables usable for fluids dispensing arrangements.

### TECHNOLOGICAL FIELD

The present disclosure is generally in the field of composite cables, particularly multipurpose composite cables usable for fluids dispensing arrangements.

### BACKGROUND

Recent developments in water dispensing systems set forth needs for augmented connectivity between separate dispensing units, for providing both fluid communication and electrical coupling between the units. Such augmented connectivity can be simply achieved utilizing separate liquid conduits and electrical cables for each of the required dedicated connection/coupling. However, if connectivity between several water dispensing units is to be achieved for distributing the dispensing of the water by the dispensing units, such simplified solutions are mostly undesired, as they are susceptible to entanglements and faults.

There is thus a need for composite cable designs suitable for fluidly communicating and electrically coupling between a plurality of water dispensing units.

### GENERAL DESCRIPTION

The present disclosure provides composite cable assemblies configured to provide fluid communication and electrical coupling between water dispensing units. The composite cable assemblies comprise a fluid tube, an electric cable, an elongated sleeve/jacket accommodating the fluid tube and electric cable, and a composite connector arrangement. At least one end of the composite cable assembly configured for establishing the required fluid communication and electrical coupling between the water dispensing units. The composite connector arrangement comprises an electrical coupler/connector electrically connected to the electric cable of the composite cable assembly, a fluid coupler/connector connected in fluid communication to the fluid tube of the composite cable assembly, and at least one partitioning means configured to physically buffer between the electrical and fluid couplers/connectors, to thereby prevent migration of fluids from the fluid coupler to the electric coupler.

The electrical coupler/connector is mounted, in some embodiments, to a movable/slidable carrier configured for axial movement inside composite connector arrangement against a pushing force applied thereon by an elastic element (e.g., spring). This mechanism is configured to provide a certain degree of freedom for movement of the composite connector arrangement with respect to the water dispensing unit, while maintaining mechanical and electrical connection of the electrical coupler/connector due to the pushing force applied over the movable/slidable carrier.

In some embodiments, the composite connector arrangement comprises at least one latching mechanism configured to secure the composite connector arrangement to the chassis of the water dispensing unit. The at least one latching mechanism can be configured to firmly attach the composite connector arrangement to the chassis of the water dispensing unit, to withstand variable transient fluid pressures occurring in the connection between, and during, fluid exchange sessions, and thereby prevent unintentional electric and/or fluid decoupling between the composite connector arrangement and the fluid dispensing unit during operation. The latching mechanism can use a type of automated self-latching device having a latching tongue configured to snap into/over a latching recess/plate provided in the chassis of the water dispensing unit. The connector may comprise a latch release push button configured to move the latching tongue from the latching recess/plate whenever the composite connector arrangement is to be disconnected from the water dispensing unit.

In some embodiments, the partitioning means is configured to provide guiding means for ensuring the electric and fluid couplers/connectors of the composite connector arrangement are introduced into respective electric and fluid couplers/connectors of the water dispensing unit in a precise orientation needed to achieve optimal fluid and electrical connectivity therebetween.

By an aspect of this disclosure, there is provided a composite cable assembly comprising a fluid tube, an electric cable, an isolating sleeve accommodating the fluid tube and the electric cable, and a composite connector arrangement. The composite connector arrangement is configured to simultaneously establish fluid communication and electrical connection with respective connectivity means of a water dispensing unit upon connection of the composite connector arrangement to the water dispensing unit. The composite connector arrangement comprises, in some embodiments, distinct isolated electrical and water connection zones. The electrical connection zone comprises an electric coupler, configured to electrically connect the electric cable of the composite cable assembly to electrical wires of the water dispensing unit, and the water connection zone comprises a fluid coupler configured to establish fluid communication between the water tube and a fluid port of the water dispensing unit.

Optionally, but in some embodiments preferably, a partitioning member is used to physically buffer between the electric and water connection zones of the composite connector arrangement for preventing passage of water from the water connection zone to the electrical connection zone. The electrical connection zone is located, in some embodiments, above the water connection zone to substantially prevent migration of water from the water connection zone to the electrical connection zone.

In some embodiments, the fluid coupler comprises a male conduit coupler. The electric cable comprises, in some embodiments, one or more wires configured to communicate control and/or data signals. Optionally, but in some embodiments preferably, the electric cable comprises at least two electric wires configured to communicate the control and/or data signals. The electric cable can comprise one or more wires configured to deliver a power supply to the water dispensing unit. Optionally, but in some embodiments preferably, at least two electric wires are used to deliver the power supply to the water dispensing unit.

In some embodiments, the electric coupler comprises female electric connection elements, each enclosed inside an electrically insulated socket.

The partitioning member is configured, in some embodiments, in form of a tongue member protruding from a surface area of the composite connector arrangement. The partitioning tongue member can be configured to guarantee proper orientation of the composite connector assembly and accurate alignment of the electric and fluid couplers when connected to the water dispensing unit.

Optionally, but in some embodiments preferably, the partitioning member is a cylindrical element configured to laterally enclose the electric coupler thereinside. The cable assembly can comprise an orienting projection axially extending along a length of the partitioning member. The orienting projection can be configured to guarantee proper orientation of the composite connector assembly and accurate alignment of the electric and fluid couplers when connected to the water dispensing unit.

In some embodiments, the electric coupler is a type of male plug connector having a number of electrically insulated electrical contacts distributed along its length. The partitioning member can be a cylindrical element configured to concentrically and laterally enclose the electric coupler thereinside. The partitioning member comprises, in some embodiments, a number of elongated openings axially extending along a length thereof for forming a plurality of arch-shaped tongues. At least one of the plurality of arch-shaped tongues can be longer, or shorter, than the other arch-shaped tongues, to establish a mechanism guaranteeing proper orientation of the composite connector arrangement and accurate alignment of the electric and fluid couplers, when connected to the water dispensing unit.

The cable assembly comprises, in some embodiments, a movable carrier and an elastic element mounted inside the composite connector arrangement. The movable carrier is configured to carry the electric coupler and move inside the composite connector arrangement against forces applied by the elastic element, to thereby provide a degree of freedom for movements of the composite connector arrangement with respect to the water dispensing unit, while maintaining electrical connection of the electric coupler (i.e. while preventing electrical disconnections).

The composite connector arrangement may comprise a fastening mechanism configured to secure the connector arrangement to the water dispensing unit upon connection thereto. Optionally, the fluid coupler is configured to be received in a locking mechanism provided in the water dispensing unit and configured to substantially immobilize it thereinside.

Optionally, an identification mechanism is provided in the composite connector arrangement to authenticate the cable assembly upon connection to the dispensing unit.

Another aspect of this disclosure provides a composite connector arrangement that comprises an electric coupler configured to establish electrical connection with electrical wires of a water dispensing unit, and a fluid coupler configured to establish fluid communication with a fluid port of the water dispensing unit. The composite connector arrangement is configured to simultaneously establish the fluid communication and electrical connection upon connection thereof to the water dispensing unit. The composite connector arrangement can have distinct isolated electrical and water connection zones, wherein the electrical connection zone comprises the electric coupler, and the water connection zone comprises the fluid coupler. A partitioning member can be used in the composite connector arrangement to physically buffer between the electrical and water connection zones and preventing passage of water from the water connection zone to the electrical connection zone.

Optionally, but in some embodiments preferably, the electrical connection zone of the composite connector arrangement is located above the water connection zone to substantially prevent migration of water from the water connection zone to the electrical connection zone. The fluid coupler of the composite connector arrangement comprises, in some embodiments, a male conduit coupler. The electric coupler of the composite connector arrangement comprises, in some embodiments, female electric connection elements, each enclosed inside an electrically insulated socket.

The partitioning member of the composite connector arrangement can be implemented by a tongue element protruding from a surface of the composite connector arrangement and configured to guarantee proper orientation of the composite connector assembly and accurate alignment of the electric and fluid couplers when connected to the water dispensing unit. Alternatively, the partitioning member of the composite connector arrangement can be implemented by a cylindrical element configured to laterally enclose the electric coupler thereinside. An orienting projection axially extending along a length of the partitioning member can be used to guarantee proper orientation of the composite connector assembly and accurate alignment of the electric and fluid couplers when connected to the water dispensing unit.

The electric coupler of the composite connector arrangement is implemented, in some embodiments, by a type of male plug connector having a number of electrically insulated electrical contacts distributed along its length. The partitioning member of the composite connector arrangement can be implemented by a cylindrical element configured to concentrically and laterally enclose this electric coupler thereinside.

In embodiments wherein the partitioning member of the composite connector arrangement is implemented by a cylindrical element, the partitioning member can have a number of elongated openings axially extending along a length thereof for forming a plurality of arch-shaped tongues. Optionally, but in some embodiments preferably, at least one of the plurality of arch-shaped tongues is made longer, or shorter, than the other arch-shaped tongues, to guarantee proper orientation of the composite connector arrangement and accurate alignment of the electric and fluid couplers, when connected to the water dispensing unit.

A fastening mechanism can be used to secure the composite connector arrangement to the water dispensing unit upon connection thereto. In some embodiments the fluid coupler is configured to be received in a locking mechanism provided in the water dispensing unit and configured to substantially immobilize it. The composite connector arrangement comprises, in some embodiments, an identification mechanism for authentication thereof. The electric coupler of the composite connector arrangement can be configured to communicate control and/or data signals. The electric coupler of the composite connector arrangement can be also configured to deliver a power supply to the water dispensing unit.

The composite connector arrangement comprises, in some embodiments, a movable carrier and an elastic element mounted inside the composite connector arrangement. The movable carrier can be configured to carry the electric coupler and move inside the composite connector arrangement against forces applied by the elastic element, to thereby provide a degree of freedom for movements of the composite connector arrangement while maintaining electrical connection of the electric coupler.

### BRIEF DESCRIPTION OF THE DRAWINGS

In order to understand the invention and to see how it may be carried out in practice, embodiments will now be described, by way of non-limiting example only, with reference to the accompanying drawings. Features shown in the drawings are meant to be illustrative of only some embodiments of the invention, unless otherwise implicitly indicated. In the drawings like reference numerals are used to indicate corresponding parts, and in which:

FIGS. 1A and 1B schematically illustrate a distributed water dispending system according to some possible embodiments, wherein FIG. 1A shows a configuration wherein a composite cable assembly is detachably connected to each water dispensing unit, and FIG. 1B shows a configuration wherein at least some of the water dispensing units comprises a composite cable assembly integrally/fixedly embedded therein for connection to another water dispensing unit of the system;

FIGS. 2A to 2D schematically illustrate a composite cable assembly, and a composite connector arrangement thereof, according to some possible embodiments, wherein FIG. 2A shows a perspective view of the composite cable and its connector, FIG. 2B demonstrates attachment of the composite connector arrangement to a water dispensing unit, FIG. 2C shows a perspective view of the composite connector arrangement, and FIG. 2D shows a sectional view of the composite connector arrangement and of a connection port of the water dispensing unit;

FIG. 3A and 3B schematically illustrate a composite connector arrangement according to some other possible embodiments, wherein FIG. 3A shows a perspective view of the composite connector arrangement, and FIG. 3B demonstrates attachment of the composite connector arrangement to a water dispensing unit;

FIGS. 4A to 4D schematically illustrate a composite connector arrangement according to some other possible embodiments, wherein FIG. 4A shows a perspective view of the composite connector arrangement, FIG. 4B demonstrates attachment of the composite connector arrangement to a water dispensing unit, FIG. 4C shows a sectional view of the composite connector arrangement and of a connection port of the water dispensing unit, and FIG. 4D shows a male plug electrical coupler of the connector arrangement;

FIGS. 5A to 5C schematically illustrate a composite connector arrangement according to some other possible embodiments, wherein FIG. 5A shows an exploded view of the composite connector assembly, and FIGS. 5B and 5C respectively show the composite connector assembly before and after connection thereof to a water dispensing unit; and

FIGS. 6A to 6C are sectional view schematically illustrating connection of the composite connector arrangement of FIGS. 5A to 5C according to some other possible embodiments to the water dispensing unit, wherein FIG. 6A shows the composite connector arrangement and the water dispensing unit before the connection between them is established, and wherein FIGS. 6B and 6C respectively show the composite connector arrangement and the water dispensing unit during and after the connection between them is established.

### DETAILED DESCRIPTION OF EMBODIMENTS

One or more specific embodiments of the present disclosure will be described below with reference to the drawings, which are to be considered in all aspects as illustrative only and not restrictive in any manner In an effort to provide a concise description of these embodiments, not all features of an actual implementation are described in the specification. Elements illustrated in the drawings are not necessarily to scale, or in correct proportional relationships, which are not critical. Emphasis instead being placed upon clearly illustrating the principles of the invention such that persons skilled in the art will be able to make and use the composite cable assemblies and their composite connector arrangements, once they understand the principles of the subject matter disclosed herein. This invention may be provided in other specific forms and embodiments without departing from the essential characteristics described herein.

The present application discloses composite cable assemblies configured to provide both fluid communication and electrical coupling between a plurality of water dispensing units configured to distribute the dispensing of one or more water products by the dispensing units. The cable assembly comprises in some embodiments a fluid tube configured for streaming the water product therethrough, electrical supply wires configured to provide electrical power supply from one water dispensing unit to another, data/control signaling wires configured to communicate data and/or control signals between the water dispensing units, and at least one composite connector arrangement having electric and fluid couplers configured for quickly and safely establishing the required fluid and electrical connectivity between the composite cable assembly and the connector port(s) of the water dispensing unit(s).

The composite cable assembly is configured, in some embodiments, to guarantee that the electrical wires of the cable assembly are substantially above/on top of the fluid tube, and electrically isolated and insulated therefrom, to thereby substantially prevent short circuits that may be caused due to water leakages. The composite connector arrangement of the composite cable assembly is configured, in some embodiments, to define separate and partitioned fluid and electrical connection zones, to prevent introduction of water from the fluid coupler to the electrical wires coupler of the composite connector arrangement.

Safety of the composite connector arrangement is further improved, in some embodiments, by utilizing a male tube coupler at the water connection zone of the composite connector arrangement and a female electrical coupler at the electrical connection zone of the composite cable assembly. Particularly, the electrical coupler of the composite connector arrangement comprises, in some embodiments, for each wire of the composite cable assembly an electrically conducting socket contained inside an electrically insulating sleeve configured to be received inside a respective electrically insulating compartment containing an electrically conducting plug of the male electrical coupler of the water dispensing unit. This way, the electrical coupling sockets of the composite connector arrangement are maintained electrically insulated at all times, and sealed electrical connection is achieved once the electrical insulated sleeves of the connector arrangement are received inside the electrically insulated compartments of the male electrical coupler of the water dispensing unit.

The composite connector arrangement comprises, in some embodiments, at least one partitioning means configured to physically buffer between its electric and fluid couplers, and thereby prevent migration of fluids (water) from the fluid coupler to the electric coupler of the composite connector arrangement.

For an overview of several example features, process stages, and principles of the invention, the examples of composite cable assemblies illustrated schematically and diagrammatically in the figures are intended for water dispensing systems/units. These water dispensing systems/units are shown as one example implementation that demonstrates a number of features, processes, and principles used to provide composite connectivity between water dispensing units, but they are also useful for other applications and to fluids other than water, and can be made in different variations. Therefore, this description will proceed with reference to the shown examples, but with the understanding that the invention recited in the claims below can also be implemented in myriad other ways, once the principles are understood from the descriptions, explanations, and drawings herein. All such variations, as well as any other modifications apparent to one of ordinary skill in the art and useful in fluid dispensing applications may be suitably employed, and are intended to fall within the scope of this disclosure.

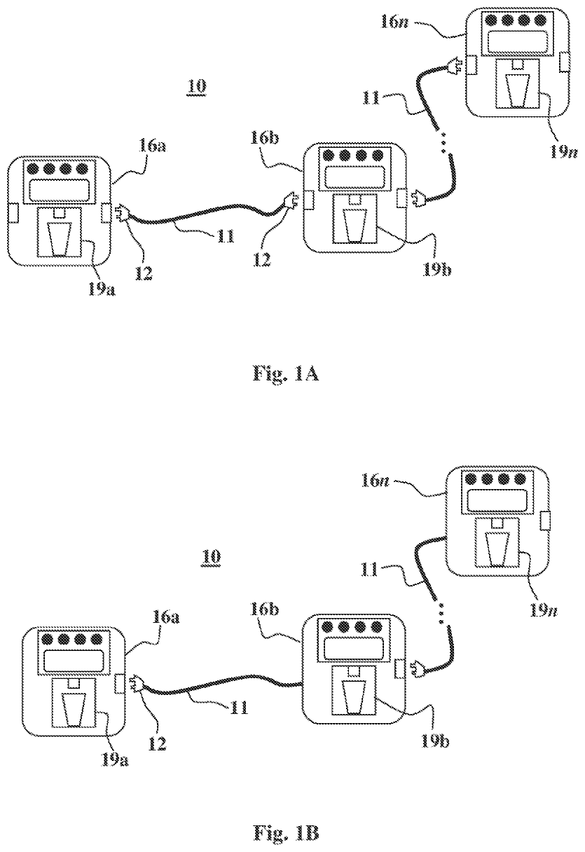

FIG. 1A schematically illustrates a liquid distribution system 10 comprising a plurality of water dispensing units 16a, 16b, . . . , 16n (collectively referred to herein as dispensing units 16), each water dispensing unit comprising a respective dispenser 19a, 19b, . . . , 19n (collectively referred to herein as dispensers 19). The dispensing units 16 are connected one to the other by composite cable assemblies 11, each composite cable assembly 11 configured to provide both fluid communication and electrical coupling between the dispensing units 16.

At least one of the dispensing units 16 is configured to apply upon demand at least one water treatment (e.g., filter, disinfect, purify, and/or distill) to a stream of source water (e.g., tap water) supplied thereto, and direct the stream of treated water product thereby produced to its dispenser 19, or to at least one other dispensing unit 16. The treated water product directed to the dispenser 19 can be processed at each dispensing unit 16 before it is dispensed, by applying one or more processes (e.g., cooling, heating, freezing, carbonation, beverage preparation, energizing, mineralizing, purifying, and/or suchlike) thereto before it is dispensed by the dispenser 19.

As seen in FIG. 1A, the composite cable assembly 11 may comprise a composite connector arrangement 12 at each of end thereof for simultaneously establishing the required fluid communication and electrical coupling with one of the dispensing units 16, upon connection thereto.

Optionally, but in some embodiments preferably, at least some of the dispensing units 16 comprise a composite cable assembly 11 integrally/fixedly connected thereto. FIG. 1B demonstrate such possible embodiment, wherein the dispensing units 16b and 16n comprises a composite cable assembly as an integral part. In this embodiment the composite cable assembly 11 is attached at one end thereof to the dispensing unit 16, and its free end is provided with a composite connector arrangement 12, for providing electrical and fluid coupling with another one of the dispensing units 16. Accordingly, at least one of the dispensing units 16 can be provided without an integral composite cable assembly, which in this non-limiting example is 16a.

The dispensing unit 16a can be the main unit configured to supply a treated (e.g., filtered) water product to at least some of the other dispensing units 16b, . . . 16n, in the system 10, as described and illustrated in co-pending and concomitantly filed Israeli Patent Application of the same Application hereof titled “liquid dispensing arrangements and methods”, filed under attorney docket No. 2709873, the disclosure of which is incorporated herein by reference. The other dispensing units 16b, . . . 16n, can be implemented by any of the secondary unit embodiments described in the above-mentioned co-pending Israeli Patent Application filed under attorney docket No. 2709873, and/or the disinfection apparatus embodiments described and illustrated in co-pending concomitantly filed Israeli Patent Application of the same Application hereof titled “Water Disinfection Apparatus”, filed under attorney docket No. 2709916, the disclosure of which is incorporated herein by reference.

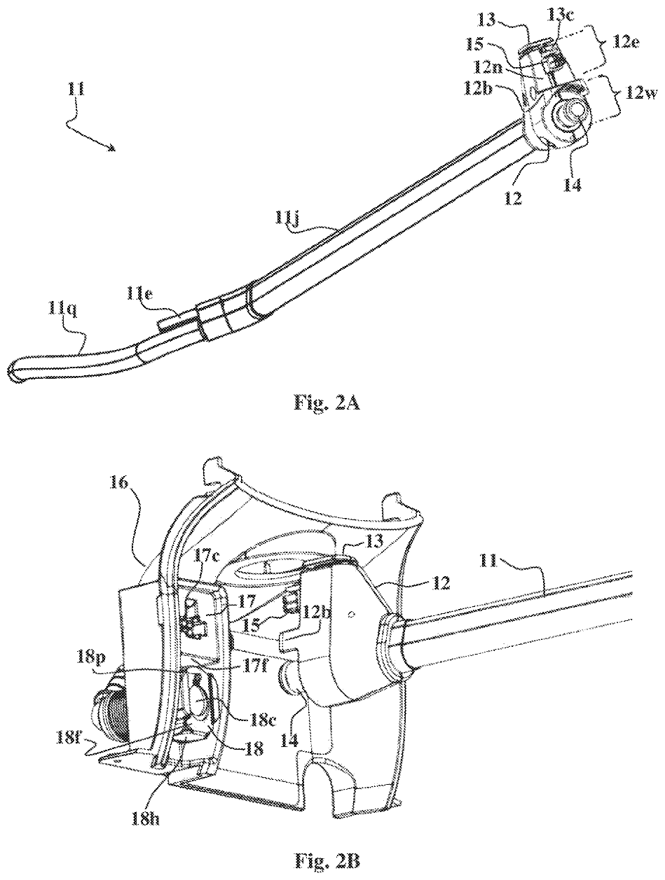

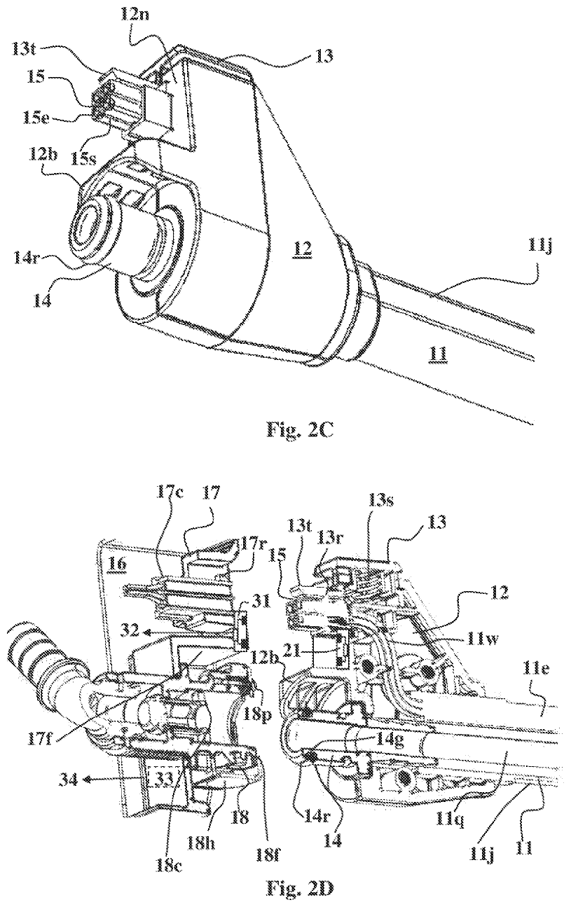

FIG. 2A shows a perspective view of a composite cable assembly 11 with the composite connector arrangement 12 at one extremity thereof. In this specific and non-limiting example the composite cable assembly 11 comprises a water tube 11q for streaming the treated water product therethrough, electrical cable 11e for establishing electrical connectivity, an isolating sleeve/jacket 11j tightly holding the water tube 11q and the electric cable 11e, and the composite connector arrangement 12 to which the sleeve 11j, water tube 11q, and electrical cable 11e, are connected.

The isolating sleeve/jacket 11j can be made of a thin flexible and/or stretchable material e.g., polyester, nylon, PET, Velcro, Mylar, Carbon fiber, Kevlar, Tinned copper, Fiberglass, or suchlike, configured to hold and substantially immobilize the water tube 11q and electrical cable 11e passing therethrough. Optionally, but in some embodiments preferably, the isolating sleeve/jacket 11j is a type of a braided sleeve/woven wrap, which may be fabricated from, or comprise, flame retardant materials.

The sleeve/jacket 11j of the composite cable assembly is configured to substantially maintain the electric cable 11e on top of the tube 11q for safety and to comply with the water and electric zones separation at the composite connector arrangement 12. Optionally, but in some embodiments preferably, the water tube 11q is made of a flexible food-grade material (food contact substance—FCS), such as, but not limited to, silicone, Teflon, Polyethylene (PE), or suchlike. Optionally, but in some embodiments preferably, the water tube 11q is a type of reinforced silicone tube. Similarly, the electric cable 11e can be a type of flexible electrical cable e.g., comprised of braided and/or stranded conductors, to thereby provide the composite cable assembly 11 sufficient flexibility for easily mounting and maneuvering it between the dispensing units 16.

The electric wires of the electric cable 11e can be made of any suitable electrically conducting material, such as, but not limited to, Copper. Optionally, but in some embodiments preferably, the electric cable 11e comprises electrically insulated power supply wires for delivering electric power supply from one dispensing unit 16 to another, and electrically insulated data/control signaling wires for exchanging data and/or control signals between the dispensing units thereby connected.

As also seen in FIG. 2A, the composite connector 12 comprises a fluid coupler 14 configured to connect to a fluid (inlet or outlet) port of one of the dispensing units 16 and establish fluid communication therewith, an electric coupler 15 configured to connect to a respective electric coupler of a dispensing unit 16, and a quick release/attachment press button 13. The front face 12n of the composite connector 12 has a generally truncated tear shape, which is partitioned into a distinct electrical connection zone 12e, in which the electric coupler is located, and a distinct fluid connection zone 12w, in which the fluid coupler 14 is located.

Optionally, but in some embodiments preferably, the fluid connection zone 12w of the composite connector arrangement 12 is located below the electrical connection zone 12e, to thereby prevent wetting the electric coupler 15 by water that may leak during connection to the dispensing unit 16. In order to further isolate between the electric coupler 15 and the fluid coupler 14, and improve safety, a partitioning assembly 12b is formed to project from the front face 12n of the composite connector arrangement 12.

The partitioning assembly 12b can be further configured to facilitate aligning between the electric and water coupling assemblies of the composite connector 12 and of the dispensing unit 16. With reference to FIGS. 2B and 2C, in this specific and non-limiting example the upper portion of the partitioning assembly 12b is made substantially flat and horizontal for sliding beneath a respective flat and horizontal wall section 17f of an electric coupling assembly 17 of the dispensing device 16, for locating the electric coupler 15 in a required height for it to precisely mate with the respective electric coupler 17c of the dispensing unit 16. The bottom portion of the partitioning assembly 12b is of circular/arch shape substantially concentric with the fluid coupler 14, for sliding over a respective circular/arched shaped portion of the fluid port 18 of the dispensing unit 16, to thereby accurately direct the fluid coupler 14 to mate with a respective fluid coupler 18c of the fluid port 18. For the sake of simplicity, FIG. 2B shows only a portion of the dispensing unit 16 containing the fluid and electric couplers, 18c and 17c.

Optionally, but in some embodiments preferably, the fluid coupler 14 comprises a cylindrical quick male fluid connector, and the electric coupler 15 comprises female electric connection elements 15e. As best seen in FIG. 2C, each of the female electric connection elements 15e of the electric coupler 15 is enclosed inside an electrically insulating socket 15s, to thereby provide electrical insulation therebetween, and substantially prevent water leakage droplets from reaching the female electric connectors 15e enclosed thereinside.

As seen in FIG. 2B, in some embodiments the fluid coupler 18c of the water dispensing unit 16 comprises a latching mechanism comprised of a ring-shaped latch plate 18f gripper configured to receive the fluid coupler 14 of the composite connector arrangement 12 therein and elastically abut thereto to securely hold and substantially immobilize it. A release pin 18p can be used to hold the ring-shaped latch plate 18f in its disengaged state before the fluid coupler 14 of the composite connector arrangement 12 is introduced therethrough. When the composite connector arrangement is connected to the water dispensing unit 16 and its front face 12n is pressed against the chassis of the water dispensing unit 16, the release pin 18p is elastically pressed inwardly (e.g., against a pushing spring—not shown) to release the disengaged latch plate 18f. In this state the latch plate 18f is elastically pressed downwardly onto the fluid coupler 14.

A release plate 18h coupled to the latch plate 18f underneath the fluid port 18 is pushed upwardly whenever the composite connector arrangement 12 is to be released from the water dispensing unit 16. Once the release plate 18h is pressed, the latch plate 18f is lifted upwardly to release its attachment over the fluid coupler 14 of the composite connector arrangement 12, and consequently the release pin 18p elastically projects outwardly to hold and immobilize the latch plate 18f in its unengaged state. In this specific and non-limiting embodiment the release plate 18h of the fluid port 18, and the press button 13 of the composite connector arrangement should be simultaneously pressed to release the composite connector arrangement 12 from the water dispensing arrangement.

In this specific and non-limiting example, the electric coupler 15 is a four sockets substantially square connector configured to connect two power supply electric wires, and two data/control signaling wires (11w in FIG. 2D), of the composite cable assembly 11 with respective electric power supply and signaling wires of the dispenser unit 16. In some embodiments the data/control signaling wires of the composite cable assembly 11 are configured for asynchronous communication between the dispensing units 16 to which the composite cable assembly 11 is connected. As seen in FIG. 2C, the front face 12n of the composite connector arrangement 12 comprises a fastening clip/latch 13t configured to snap onto/over a respective fastening ledge (17r in FIG. 2D) of the dispenser unit 16, and securely hold the composite connector arrangement 12 in place once connected thereto.

FIG. 2D shows a sectional view of the composite connector arrangement 12, and of respective couplers of the dispensing unit 16. As seen, the quick release/attachment press button 13 is coupled to the fastening clip 13t, and it is forced to maintain its closed (fastened) state by a press spring 13s. The fastening clip 13t is configured to move about a levering element 13r for elevating the distal end of the fastening clip 13t whenever the press button 13 is pressed against the upward force of the press spring 13s. In addition, the fluid coupler 14 comprises an O-ring 14r fitted into a circular groove 14g and configured to sealably fasten the fluid coupler 14 to the fluid coupler 18c of the fluid port 18. This way, upon connecting the composite connector arrangement 12 to the dispensing unit 16, the fastening clip 13t snaps onto the fastening ledge 17r, the latch plate 18f is pressed about the fluid coupler 14, and the O-ring 14r is tightly fitted into the fluid coupler 18c of the dispensing assembly, thereby firmly securing the composite connector arrangement 12 to the dispensing unit 16, and establishing the required fluid communication and electrical connectivity.

Optionally, and in some embodiments preferably, the composite connector arrangement 12 comprises an identification mechanism configured to prevent use of unauthorized (e.g., counterfeit) cables with the dispensing units 16. A respective detection circuitry 31 can be used in the dispensing unit 16 for identifying the presence of the identification circuitry 21 upon connection of the composite cable assembly 11, and responsively issuing an authorization signal 32. The dispensing unit 16 can be configured to permit water passage and electric connection via the composite cable assembly 11 only after the authorization signal 32 is issued by detection circuitry 31, to thereby prevent usage of unauthorized/counterfeit cables/tubes. The detection circuitry 31 can be configured to establish electric contact with identification circuitry 21 and responsively issue the authorization signal 32.

In possible embodiments the identification circuitry 21 may have an embedded identifier, and the detection circuitry 31 can be configured to fetch the identifier embedded in the identification circuitry 21 and incorporate it in the authorization signal 32 thereby issued. The dispensing unit 16 can be configured to permit water passage and electric connection via composite cable assembly 11 after extracting and validating the identifier received with the authorization signal 32. Alternatively, or additionally, micro-switches 33 can be used in the dispensing unit 16 configured for identifying simultaneous connection of the fluid coupler 14 and the electric coupler 15 and responsively issue a permission signal 34 used by the dispensing unit 16 to permit usage of the composite cable assembly 11, to thereby prevent use of separately connected fluid tube and electric cable.

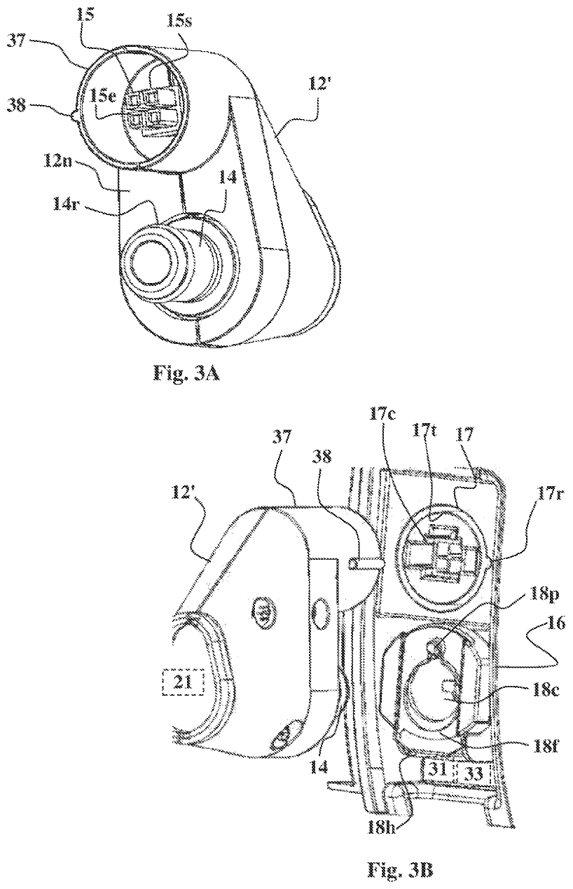

FIGS. 3A and 3B schematically illustrates another possible composite connector arrangement 12′ according to some possible embodiments. The composite connector arrangement 12 (shown in FIGS. 2A-D) and 12′ share many similar features designated by same reference numerals. The main difference between these composite connector arrangements is in replacing the arched-shaped partitioning assembly 12b of composite connector arrangement 12 by a cylindrical partitioning assembly 37 in which the electric coupler 15 is laterally enclosed. The cylindrical partitioning assembly 37 is configured to physically buffer between the electric and fluid couplers, and to thereby prevent migration of fluids from the fluid coupler 14 to the electric coupler 15.

The cylindrical partitioning assembly 37 comprises an orienting projection 38 axially extending along a length thereof. The orienting projection 38 is configured to guide, and accurately orient, the insertion of the electric and fluid couplers, 15 and 14, of the composite connector arrangement 12′ to their corresponding couplers, 17c and 18c, of the water dispensing unit 16. The electric coupling assembly 17 is configured to receive the cylindrical partitioning assembly 37 in a respective cylindrical socket 17t, and guarantee accurate alignment of the fluid and electric couplers by receiving the orienting projection 38 inside the guiding channel 17r extending along a length of the internal wall of the cylindrical socket 17t. In addition, the composite connector arrangement 12′ is configured without the fastening clip/latch 13t and its press button 13, relying mainly on the ring-shaped latch plate 18f gripper of the fluid port 18 to maintain the connector arrangement immobilized once it is connected to the water dispensing unit 16.

As shown in FIG. 3B, the composite connector assembly 12′ may have an identification circuitry 21, as described with reference to FIG. 2D, and the dispensing unit 16 may have a corresponding detection circuitry 31 for identifying the presence of the identification circuitry 21 in the composite connector 12′, when connection to the dispensing unit 16 is established, and permit usage of the composite cable assembly 11. Alternatively, or additionally, micro-switches 33 can be used in the dispensing unit 16 for identifying simultaneous connection of the fluid coupler 14 and the electric coupler 15, and permit usage of the composite cable assembly 11, as described hereinabove with reference to FIG. 2D.

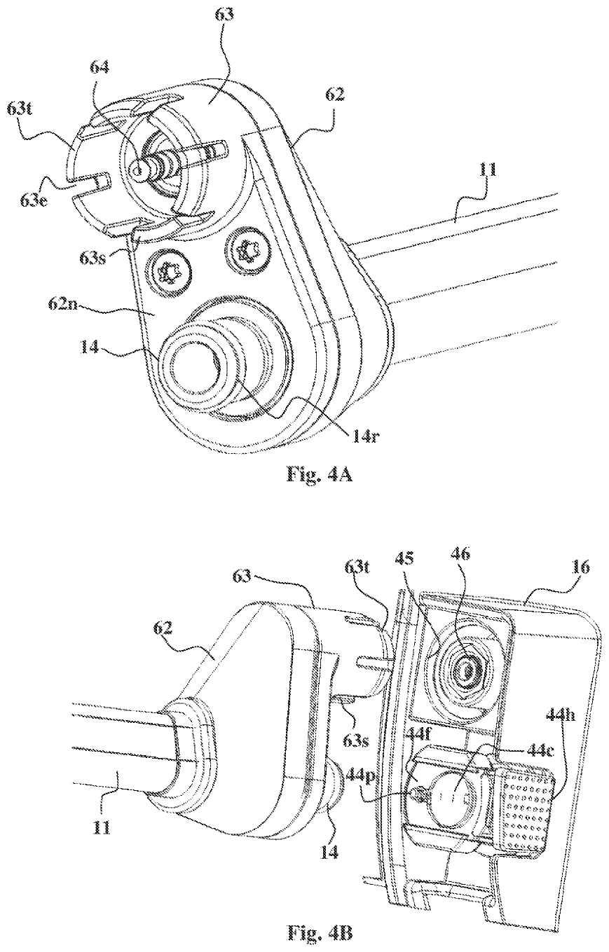

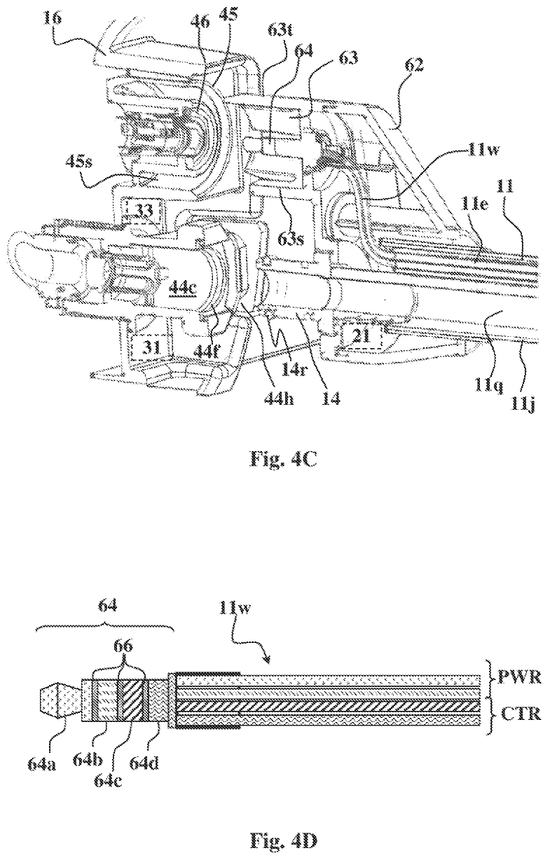

FIGS. 4A to 4D show another possible composite connector arrangement 62 according to some possible embodiments. The composite connector arrangement 12 (shown in FIGS. 2A-D) and 62 share many similar features designated by same reference numerals. The main difference between these composite connector arrangements is in electric coupler 64 and the partitioning assembly 63 of the composite connector arrangement 62, as explained in details hereinbelow. As seen in FIG. 4A, the electric coupler 64 is a type of four pole male plug connector having four electrically insulated electrical contacts along its length. This configuration of the electric coupler 64 substantially simplifies the attachment procedure of the composite connector assembly 62, as it requires insertion of a single contact element into a corresponding electric female coupler (46 in FIG. 4B) provided in the water dispensing unit 16.

The partitioning assembly 63 is a cylindrically-shaped element configured to concentrically and laterally enclose the electric coupler 64. A distal portion of the partitioning assembly 63 comprises a number of elongated openings 63e axially extending along a length thereof, thereby forming a plurality of arch-shaped tongues 63t. The arch-shaped tongues 63t are configured to provide some level of elasticity to the partitioning assembly 63 for facilitating insertion thereof into a respective cylindrical socket (45 in FIG. 4B) of the water dispensing unit 16. In some possible embodiments at least one arch-shaped tongue 63s of the partitioning assembly 63 is made shorter, or longer, than the other arch-shaped tongues 63t, to thereby provide attachment orienting means, as will be explained hereinbelow in details.

FIG. 4B demonstrates attachment of the composite connector arrangement 62 to the water dispensing unit 16. As seen, the water dispensing unit 16 comprises a four pole female electric coupler 46 concentrically enclosed inside a cylindrical socket 45 configured to snugly receive the cylindrical partitioning assembly 63. In this specific and non-limiting example one arch-shaped tongue 63s of the cylindrical partitioning assembly 63 is shorter than the other arch-shaped tongues 63t to guarantee that the cylindrical partitioning assembly 63 is inserted into the cylindrical socket 45 in proper orientation.

The fluid coupler 44c of the water dispensing unit 16 comprises a laterally oriented gripping mechanism having a lateral release button 44h configured to laterally move the ring-shaped latch plate 44f for releasing its grip over the fluid coupler 14 whenever the composite connector assembly 62 is disconnected from the water dispensing unit 16. In this case, the release pin 44p is located at an opposite lateral side of the fluid coupler 44c, and it is configured to be elastically pushed inwardly when pushed by the front face 62n of the composite connector arrangement 62, to thereby release the ring-shaped latch plate 44f to hold and immobilize the fluid coupler 14 once inserted into the female fluid coupler 44c of the water dispensing unit 16. When the lateral release button 44h is pushed towards the fluid coupler 44c, the release pin 44p elastically projects outwardly to hold the ring-shaped latch plate 44f in its disengaged state to thereby allow removal of the male fluid coupler 14 from the female fluid coupler 44c.

FIG. 4C shows a sectional view of the composite connector assembly 62 and of a portion of the water dispensing unit 16. As seen, the cylindrical socket 45 in this non-limiting example is configured to define a limiting cavity 45s which depth is shorter than the depth of the other sections of the cylindrical socket 45, and configured to receive the shorter arch-shaped tongue 63s of the cylindrically-shaped partitioning assembly 63. This configuration of the cylindrical socket 45 is used to prevent improper attachment of the composite connector arrangement 62 to the water dispensing unit 16, and to accurately guide the electric and fluid couplers, 64 and 14, of the composite connector arrangement 62 to mate with their respective couplers, 46 and 44c, at the water dispensing unit 16.

As also shown in FIG. 4C, the composite connector assembly 62 may have an identification circuitry 21, as described with reference to FIG. 2D, and the dispensing unit 16 may have a corresponding detection circuitry 31 for identifying the presence of the identification circuitry 21 in the composite connector assembly 62, when connection to the dispensing unit 16 is established, to permit usage of the composite cable assembly 11. Alternatively, or additionally, micro-switches 33 can be used in the dispensing unit 16 for identifying simultaneous connection of the fluid coupler 14 and the electric coupler 15, and permit usage of the composite cable assembly 11.

FIG. 4D shows principal structure of the electric coupler 64 according to some possible embodiments. The electric coupler 64 is a generally elongated cylindrical element comprising four electric contact areas 64a, 64b, 64c and 64d, arranged along its length and separated by electrically insulating elements 66. Each of the electric wires 11w of the composite cable assembly 11 is electrically connected to a respective one of the electric contact areas 64a, 64b, 64c and 64d, of the electric coupler 64. In this non-limiting example two of the wires CTR are used to communicate control and/or data signals, and two other wires PWR are used for low voltage power supply. Any other arrangement/order of the wires is of course possible.

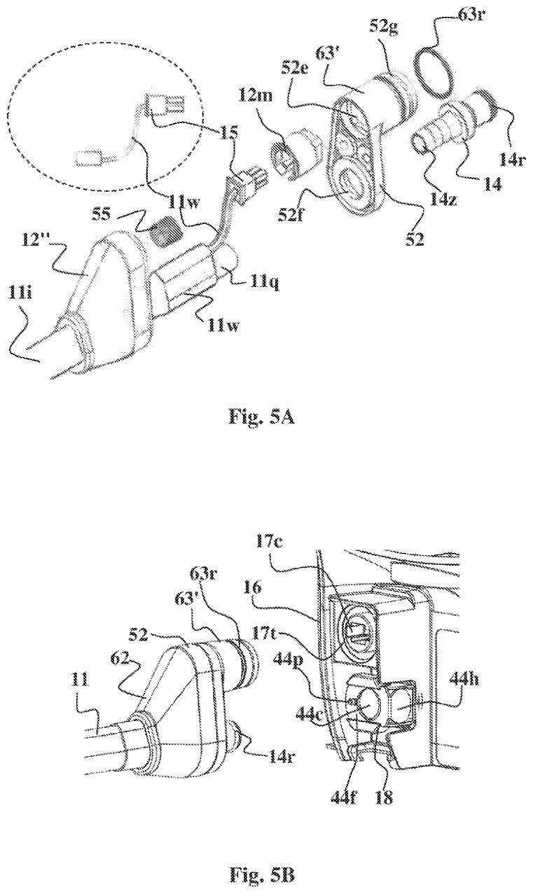

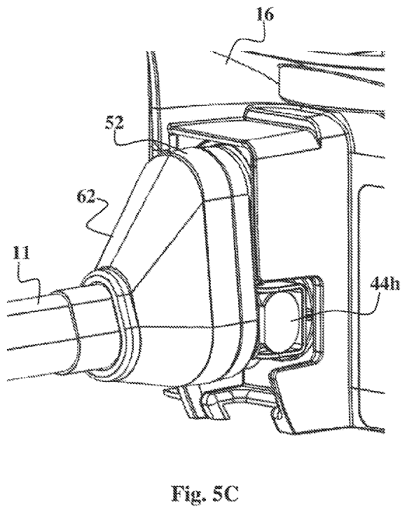

FIGS. 5A to 5C schematically illustrate a composite connector arrangement 12″ according to some other possible embodiments. The composite connector arrangements 12′ (shown in FIGS. 3A and 3B) and 12″ share many similar features designated by same reference numerals. As explained hereinbelow in details, the main differences between these composite connector arrangements is in the configuration of the partitioning assembly 63′, and the connection mechanism of the electric coupler 15, of the composite connector arrangement 12″.

As seen in FIG. 5A, the partitioning assembly 63′ perpendicularly extends from a closure element 52 of the composite connector arrangement 12″, and in this non-limiting example an orienting projection 38 is not used. Optionally, a circular groove 52g is formed about the partitioning assembly 63′ for placing an O-ring 63r therein for reducing movement and for sealable connection to the cylindrical socket 17t of the water dispensing units 16, to thereby prevent unintentional disconnection and water and/or moisture from entering the electrical contacts. The closure element 52 comprises an electric connector opening 52e configured for passage of the electric coupler 15 therethrough, and a water connector opening 52f configured for passage of the fluid coupler 14 therethrough.

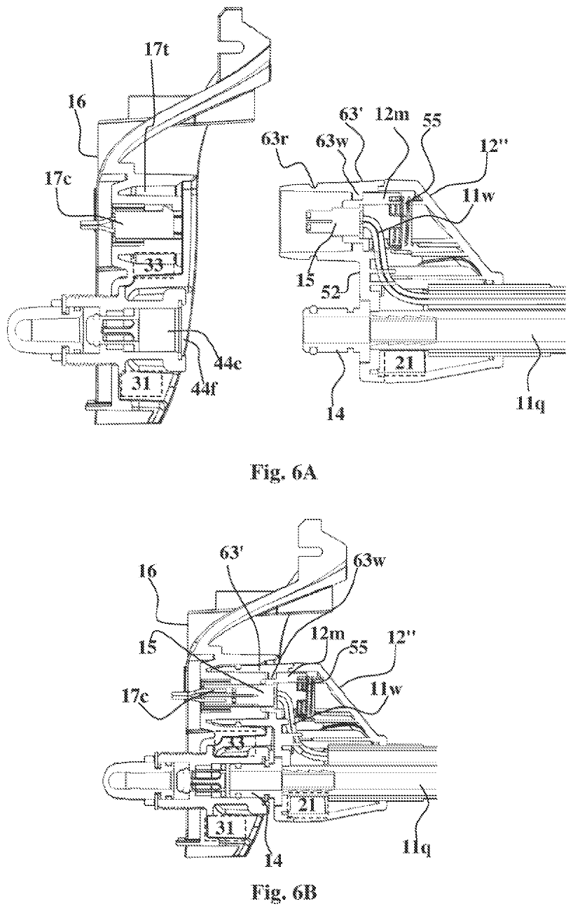

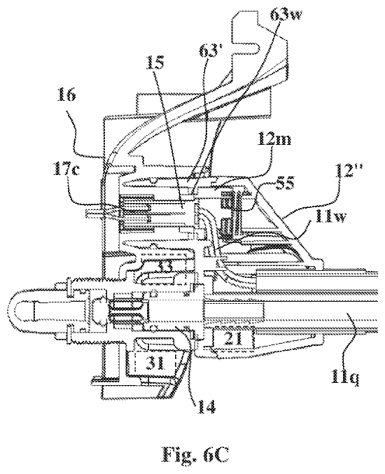

In this embodiment the electric coupler 15 is held by a slidable carrier 12m movably mounted inside the composite connector arrangement 12″ and pressed by an elastic element (e.g., spring) 55 against an inner wall portion (63w in FIGS. 6A to 6C) of the closure element 52. The fluid coupler 14 comprises a male connector portion 14z configured to be externally introduced through the water connector opening 52f into the composite connector arrangement 12″ and firmly and sealably received in a distal opening of the water tube 11q. As shown on FIG. 5B, the water dispensing unit 16 comprises a laterally oriented gripping mechanism having a lateral release button 44h configured to laterally move the ring-shaped latch plate 44f for releasing its grip over the fluid coupler 14, and ejecting the release pin 44p, as described hereinabove in details with reference to FIGS. 4B and 4C.

FIG. 5C shows the composite connector arrangement 12″ after the electric coupler 15 is received in the electric coupler 17c of the dispensing unit 16, and the fluid coupler 14 is received in the fluid coupler 44c of the water dispensing unit 16. In this state the O-rings, 63r and 14r, are tightly received inside their respective socket 17t and coupler 44c, and the release pin 44p is pressed inwardly to release the latch plate 44f, to thereby form a grip over the fluid coupler 14 and immobilize the composite connector arrangement 12″ in place.

FIGS. 6A to 6C are sectional views schematically illustrating connection of the composite connector arrangement 12″ to the water dispensing unit 16. FIG. 6A shows the composite connector arrangement 12″ before it is connected to the water dispensing unit 16. As seen, in this state the slidable carrier 12m is pressed by the elastic element 55 against the inner wall portion 63w of the closure element 52.

FIGS. 6B shows the composite connector arrangement 12″ during its connection to the water dispensing unit 16, before the latch plate 44f is released into its engaged state. As shown, in this state the electric coupler 15 is received in the electric coupler 17c of the water dispensing unit 16, but the partitioning assembly 63′ and the fluid coupler 14 are not fully received in the socket 17t and coupler 44c of the water dispensing unit 16, respectively i.e. , sealable connection of the water dispensing unit 16 is not yet established.

FIG. 6C shows the composite connector arrangement 12″ once it is fully connected to the water dispensing unit 16. In this state partitioning assembly 63′ and the fluid coupler 14 are fully and sealably received in the socket 17t and coupler 44c of the water dispensing unit 16, respectively, and the latch plate 44f is released into its engaged state to immobilize the composite connector arrangement 12″ in place. As the composite connector arrangement 12″ transits between the states shown in FIGS. 6B and 6C the slidable carrier 12m abuts a wall potion of the water dispensing unit 16 and thus become immobilized while all other elements of the composite connector arrangement 12″ are further moved towards engagement with the respective couplers of the water dispensing unit 16. The abutment of the slidable carrier 12m to the wall potion of the water dispensing unit 16 thus cause the elastic element 55 to become compressed as the couplers of the composite connector arrangement 12″ are further pushed into the couplers of the water dispensing unit 16.

The compression of the elastic element 55 in the fully connected state of the composite connector arrangement 12″ is configured to keep the electric coupler 15 in mechanic and electric connection with the electric coupler 17c of the water dispensing unit 16, and to prevent disconnection if, for any reason, the composite connector arrangement 12″ is accidently displaced after the connection is established. For example, if a force is applied on the composite connector arrangement 12″ after it is connector to the water dispensing unit 16, due to the locking by the latch plate 44f over the fluid coupler 14 the partitioning assembly 63′ can be displaced and moved outwardly from the cylindrical socket 17t. However, due to the pressure force applied by the elastic element 55 such outward displacements of the partitioning assembly 63′ will not move the electric coupler 15, which will thus maintain its mechanic and electric connection to the coupler 17c of the water dispensing unit 16.

This configuration of the electric coupling mechanism provide some degree of freedom for movement of the elements of the composite connector arrangement 12″ with respect to the water dispensing unit 16. In some embodiments the electric coupling mechanism is configured to permit outward displacements of the composite connector arrangement 12″ of about 2.5 mm, while maintaining the electric coupler 15 in mechanic and electric connection with the coupler 17c of the water dispensing unit 16.

As shown in FIGS. 6A to 6C, an identification circuitry 21 and a corresponding detection circuitry 31 can be used as described hereinabove in details for authenticating the composite cable assembly. Alternatively, or additionally, the micro-switches 33 can be used for identifying simultaneous connection of the fluid and electric couplers. The different elements and components of the composite connector arrangements shown in specific figures and described hereinabove with respect to a respective specific embodiment can be used in any other one of the embodiments shown and described hereinabove with respect to any other figure.

Terms such as top, bottom, front, back, right, and left and similar adjectives in relation to orientation of the composite cable assembly, and/or the composite connector arrangement, and components thereof, refer to the manner in which the illustrations are positioned on the paper, not as any limitation to the orientations in which the apparatus can be used in actual applications.

1. A composite cable assembly comprising a fluid tube, an electric cable, an isolating sleeve accommodating said fluid tube and electric cable, and a composite connector arrangement, said composite connector arrangement configured to simultaneously establish fluid communication and electrical connection with respective connectivity means of a water dispensing unit upon connection of the composite connector arrangement to said water dispensing unit.

2. The cable assembly of claim 1, comprising distinct isolated electrical and water connection zones in the composite connector arrangement, said electrical connection zone comprising an electric coupler configured to electrically connect the electric cable of the composite cable assembly to electrical wires of the water dispensing unit, and said water connection zone comprising a fluid coupler configured to establish fluid communication between the water tube and a fluid port of the fluid dispensing unit.

3. The cable assembly of claim 1, comprising a partitioning member physically buffering between the electrical and water connection zones of the composite connector arrangement for preventing passage of water from the water connection zone to the electrical connection zone, wherein the electrical connection zone is located above the water connection zone to substantially prevent migration of water from the water connection zone to the electrical connection zone.

4. (canceled)

5. (canceled)

6. (canceled)

7. The cable assembly of claim 2, wherein the partitioning member is implemented by a tongue element protruding from a surface of the composite connector arrangement and configured to guarantee proper orientation of the composite connector assembly and accurate alignment of the electric and fluid couplers when connected to the water dispensing unit.

8. The cable assembly of claim 2, wherein the partitioning member is a cylindrical element configured to laterally enclose the electric coupler thereinside.

9. (canceled)

10. The cable assembly of claim 2, wherein the electric coupler is a type of male plug connector having a number of electrically insulated electrical contacts distributed along its length.

11. (canceled)

12. The cable assembly of claim 8, wherein the partitioning member comprises a number of elongated openings axially extending along length thereof for forming a plurality of arch-shaped tongues.

13. The cable arrangement of claim 12, wherein at least one of the plurality of arch-shaped tongues is longer, or shorter, than the other arch-shaped tongues, to guarantee proper orientation of the composite connector arrangement and accurate alignment of the electric and fluid couplers, when connected to the water dispensing unit.

14. (canceled)

15. The cable assembly of claim 1, wherein the fluid coupler is configured to be received in a locking mechanism provided in the water dispensing unit and configured to substantially immobilize it.

16. (canceled)

17. The cable assembly of claim 1, wherein the electric cable comprises at least one electric wire configured to communicate control and/or data signals, and/or deliver a power supply to the water dispensing unit.

18. (canceled)

19. The cable assembly of claim 1, comprising a movable carrier and an elastic element mounted inside the composite connector arrangement, said movable carrier configured to carry the electric coupler and move inside said composite connector arrangement against forces applied by said elastic element, to thereby provide a degree of freedom for movements of said composite connector arrangement while maintaining electrical connection of said electric coupler.

20. A composite connector arrangement comprising an electric coupler configured to establish electrical connection with electrical wires of a water dispensing unit, and a fluid coupler configured to establish fluid communication with a fluid port of said water dispensing unit, said composite connector arrangement configured to simultaneously establish said fluid communication and electrical connection upon connection thereof to said water dispensing unit.

21. The composite connector arrangement of claim 20, comprising distinct isolated electrical and water connection zones, said electrical connection zone comprising the electric coupler, and said water connection zone comprising the fluid coupler.

22. The composite connector arrangement of claim 21, comprising a partitioning member physically buffering between the electrical and water connection zones for preventing passage of water from said water connection zone to said electrical connection zone.

23. (canceled)

24. The composite connector arrangement of claim 22, wherein the electrical connection zone is located above the water connection zone to substantially prevent migration of water from the water connection zone to the electrical connection zone.

25. The composite connector arrangement of claim 22, wherein the partitioning member is a cylindrical element configured to laterally enclose the electric coupler thereinside.

26. (canceled)

27. The composite connector arrangement of claim 22, wherein the electric coupler is a type of male plug connector having a number of electrically insulated electrical contacts distributed along its length, wherein the partitioning member is a cylindrical element configured to concentrically and laterally enclose the electric coupler thereinside.

28. (canceled)

29. The composite connector arrangement of claim 25, wherein the partitioning member comprises a number of elongated openings axially extending along length thereof for forming a plurality of arch-shaped tongues, and wherein at least one of the plurality of arch-shaped tongues is longer, or shorter, than the other arch-shaped tongues, to guarantee proper orientation of the composite connector arrangement and accurate alignment of the electric and fluid couplers, when connected to the water dispensing unit.

30. (canceled)

31. (canceled)

32. The composite connector arrangement of claim 20, wherein the fluid coupler is configured to be received in a locking mechanism provided in the water dispensing unit and configured to substantially immobilize it.

33. The composite connector arrangement of claim 20, comprising an identification mechanism for authentication thereof.

34. The composite connector arrangement of claim 20, wherein the electric coupler comprises is configured to communicate control and/or data signals, and/or to deliver a power supply to the water dispensing unit.

35. (canceled)

36. The composite connector arrangement of claim 20, comprising a movable carrier and an elastic element mounted inside the composite connector arrangement, said movable carrier configured to carry the electric coupler and move inside said composite connector arrangement against forces applied by said elastic element, to thereby provide a degree of freedom for movements of said composite connector arrangement while maintaining electrical connection of said electric coupler.

37. (canceled)

38. (canceled)
